(19) United States
(12) Patent Application Publication
(10) Pub. No.: US 2016/0198766 A1
(43) Pub. Date: Jul. 14, 2016

(54) BATTERY COMPONENT AND ELECTRONIC CIGARETTE

(71) Applicant: KIMREE HI-TECH INC., Tortola (VG)

(72) Inventor: Qiuming Liu, Shenzhen, Guangdong (CN)

(21) Appl. No.: 14/912,168

(22) PCT Filed: Aug. 16, 2013
(86) PCT No.: PCT/CN2013/081703

§ 371 Date: Feb. 16, 2016

(51) Int. Cl. A24F 47/00; H01M 2/10; H02J 7/00

(52) U.S. Cl. CPC A24F 47/008; H02J 7/0042; H01M 2/1055; H01M 2220/30

(57) ABSTRACT

A battery component and an electronic cigarette are disclosed. The battery component comprises an outer sleeve pipe and a battery. The battery comprises a first electrode and a second electrode. The battery component also comprises a first charging electrode-arranged at an one end of the outer sleeve pipe and electrically connected to the first electrode, and a second charging electrode arranged on the outer wall of the outer sleeve pipe and electrically connected to the second electrode. The beneficial effect of implementing the present invention is that: the battery component employs the first charging electrode arranged on one end of the outer sleeve pipe and the second charging electrode arranged on the outer wall of the outer sleeve pipe, when charging the battery component, only the first charging electrode and the second charging electrode need to be inserted into a charger, thus conserving charging operation time.

### TECHNICAL FIELD

The present application relates to the technical field of daily electronic products, and more particularly, relates to a battery component and an electronic cigarette.

### BACKGROUND

An electronic cigarette comprises a battery component and an atomization component. Existing electronic cigarettes can be divided into disposable electronic cigarettes and non-disposable electronic cigarettes. Generally, the disposable electronic cigarettes can not be charged, and the tobacco tar inside the disposable electronic cigarettes usually can not be fully used when using the electronic cigarette of this type, which results in a waste of the tobacco tar. However, in a non-disposable electronic cigarette, a battery component is detachably connected to an atomization component, and a charging port of the battery component is an electrode connecting element of the battery component, which is configured to be connected to the atomization component. When charging the battery component, the atomization component needs to be detached from the battery component firstly, and only after that the battery component is charged. The charging principle is as shown in FIG. 1. When using the charging method of this type, the charging is time-consuming, and the connection between the battery component and the atomization component may be worn or loose after being used for a long time. Furthermore, the atomization component may be easily lost when it is taken down from the battery component, which brings a lot of inconveniences for the usage of the user.

### BRIEF SUMMARY

The objective of the present application is to provide a battery component and an electronic cigarette, of which the charging process is convenient.

In accordance with one aspect of the present application, a battery component is constructed, which is configured to be assembled with an atomization component to form an electronic cigarette, and comprises an outer sleeve pipe and a battery arranged in the outer sleeve pipe; the battery includes a first electrode and a second electrode; wherein the battery component further includes a first charging electrode which is arranged at one end of the outer sleeve pipe and further electrically connected to the first electrode, and a second charging electrode which is arranged on an outer wall of the outer sleeve pipe and further electrically connected to the second electrode; the first charging electrode and the second charging electrode are configured to be connected to an external charger.

In the battery component according to the present application, the battery component further includes a lamp cap which is inserted in the end of the outer sleeve pipe; the first charging electrode runs through the lamp cap and is further electrically connected to the first electrode.

In the battery component according to the present application, wherein an end face of the first charging electrode and an end face of the lamp cap together form an even surface.

In the battery component according to the present application, wherein an inserting hole configured for the first charging electrode to run through is defined in the lamp cap, while a gap in shape of a barrel is formed between the first charging electrode and the inserting hole.

In the battery component according to the present application, wherein an inserting hole configured for the first charging electrode to run through is defined in the lamp cap, while a charging hole is defined in the first charging electrode along an axis direction of the lamp cap.

In the battery component according to the present application, wherein the battery component further includes a first electrode connecting element and the second electrode connecting element which are respectively arranged on the other end of the outer sleeve pipe that is opposite to the first charging electrode; the first electrode connecting element is electrically connected to the first electrode, while the second electrode connecting element is electrically connected to the second electrode; the second charging electrode is abutted against the second electrode connecting element.

In the battery component according to the present application, wherein the second charging electrode is an electrode tube which is sleeved on the outer wall of the outer sleeve pipe; an end of the electrode tube is abutted against the second electrode connecting element.

In the battery component according to the present application, wherein the electrode tube is made from conductive papers.

In the battery component according to the present application, wherein the second charging electrode is an electrode slice which is arranged on the outer wall of the outer sleeve pipe; an end of the electrode slice is abutted against the second electrode connecting element.

In the battery component according to the present application, the battery component further includes a controlling module which is configured to control the atomization component to work; the controlling module includes a first electrode terminal which is electrically connected to the first electrode, and a second electrode terminal which is electrically connected to the second electrode; the first charging electrode is abutted against the first electrode terminal;

when the charger is charging the battery, the controlling module disconnect the battery from the atomization component.

In accordance with another aspect of the present application, an electronic cigarette is further provided, which comprises a battery component; wherein the battery component includes an outer sleeve pipe and a battery arranged in the outer sleeve pipe; the battery comprises a first electrode and a second electrode; the electronic cigarette further includes an atomization component arranged in the outer sleeve pipe; wherein the battery component further includes a first charging electrode which is arranged at one end of the outer sleeve pipe and further electrically connected to the first electrode, and a second charging electrode which is arranged on an outer wall of the outer sleeve pipe and further electrically connected to the second electrode; the first charging electrode and the second charging electrode are configured to be connected to an external charger.

In the electronic cigarette according to the present application, wherein the outer sleeve pipe includes a battery sleeve tube and an atomization sleeve tube detachably connected to the battery sleeve tube; the battery is arranged in the battery sleeve tube; the first charging electrode is arranged at one end of the battery sleeve tube that is opposite to the atomization sleeve tube, while the second charging electrode is arranged on an outer wall of the battery sleeve tube; the atomization component is arranged in the atomization sleeve tube.

In the electronic cigarette according to the present application, wherein the battery component further includes a lamp cap which is inserted in the end of the battery sleeve tube that is opposite to the atomization sleeve tube; the first charging electrode runs through the lamp cap and is further electrically connected to the first electrode.

In the electronic cigarette according to the present application, wherein an end face of the first charging electrode and an end face of the lamp cap together form an even surface.

In the electronic cigarette according to the present application, wherein an inserting hole configured for the first charging electrode to run through is defined in the lamp cap, while a gap in shape of a barrel is formed between the first charging electrode and the inserting hole.

In the electronic cigarette according to the present application, wherein the battery component further includes a first electrode connecting element and the second electrode connecting element which are respectively arranged on the other end of the battery sleeve tube that is opposite to the first charging electrode; the first electrode connecting element is electrically connected to the first electrode, while the second electrode connecting element is electrically connected to the second electrode; the second charging electrode is abutted against the second electrode connecting element.

In the electronic cigarette according to the present application, wherein the second charging electrode is an electrode tube which is sleeved on the outer wall of the battery sleeve tube; an end of the electrode tube is abutted against the second electrode connecting element.

In the electronic cigarette according to the present application, wherein the electrode tube is made from conductive papers.

In the electronic cigarette according to the present application, wherein the second charging electrode is an electrode slice which is arranged on the outer wall of the battery sleeve tube; an end of the electrode slice is abutted against the second electrode connecting element.

In the electronic cigarette according to the present application, wherein the battery component further includes a controlling module which is configured to control the atomization component to work; the controlling module includes a first electrode terminal which is electrically connected to the first electrode, and a second electrode terminal which is electrically connected to the second electrode; the first charging electrode is abutted against the first electrode terminal;

when the charger is charging the battery, the controlling module disconnect the battery from the atomization component.

When implementing the battery component and the electronic cigarette of the present application, the following advantageous can be achieved: since the battery component employs the first charging electrode which is arranged at one end of the outer sleeve pipe, and the second charging electrode which is arranged on the outer wall of the outer sleeve pipe, when charging the battery component, only the first charging electrode and the second charging electrode need to be inserted into the external charger, thereby saving the charging time. Furthermore, since there is no need to separate the battery sleeve tube and the atomization sleeve tube from each other, it is possible to ensure a reliable connection between the battery sleeve tube and the atomization sleeve tube, which brings lots of conveniences to the users.

### BRIEF DESCRIPTION OF THE DRAWINGS

The present application will be further described with reference to the accompanying drawings and embodiments in the following, in the accompanying drawings:

FIG. 1 is a block diagram showing a charging principle of an existing electronic cigarette;

FIG. 2 is an explored view of a battery component according to a first preferred embodiment of the present application;

FIG. 3 is a schematic view of the battery component shown in FIG. 2;

FIG. 4 is an enlarged view of Part A shown in FIG. 3;

FIG. 5 is a block diagram showing a charging principle when the battery component shown in FIG. 2 is connected to an atomization component;

FIG. 6 is a view showing an inner structure of the battery component shown in FIG. 2 after an outer sleeve pipe of the battery component is removed;

FIG. 7 is a schematic view of a battery component according to a second preferred embodiment of the present application;

FIG. 8 is a schematic view of a battery component according to a third preferred embodiment of the present application;

FIG. 9 is a schematic view of a battery component according to a fourth preferred embodiment of the present application;

FIG. 10 is a schematic view of an electronic cigarette according to a first preferred embodiment of the present application; and

FIG. 11 is a schematic view of an electronic cigarette according to a second preferred embodiment of the present application.

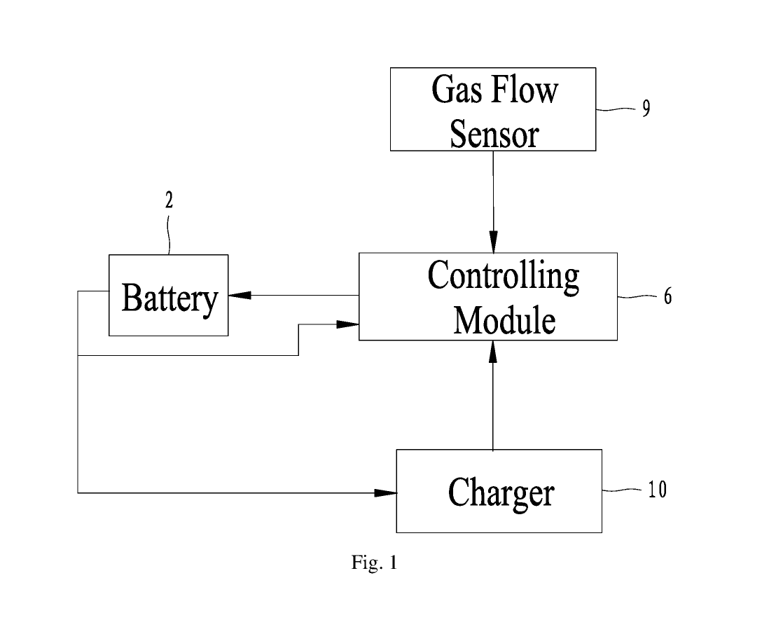

### DETAILED DESCRIPTION OF THE PREFERRED EMBODIMENT

In order to make the technical features, the propose and the technical effect of the present application more clearly, the specific implemental means of the present application will now be described in detail with reference to the accompanying drawings.

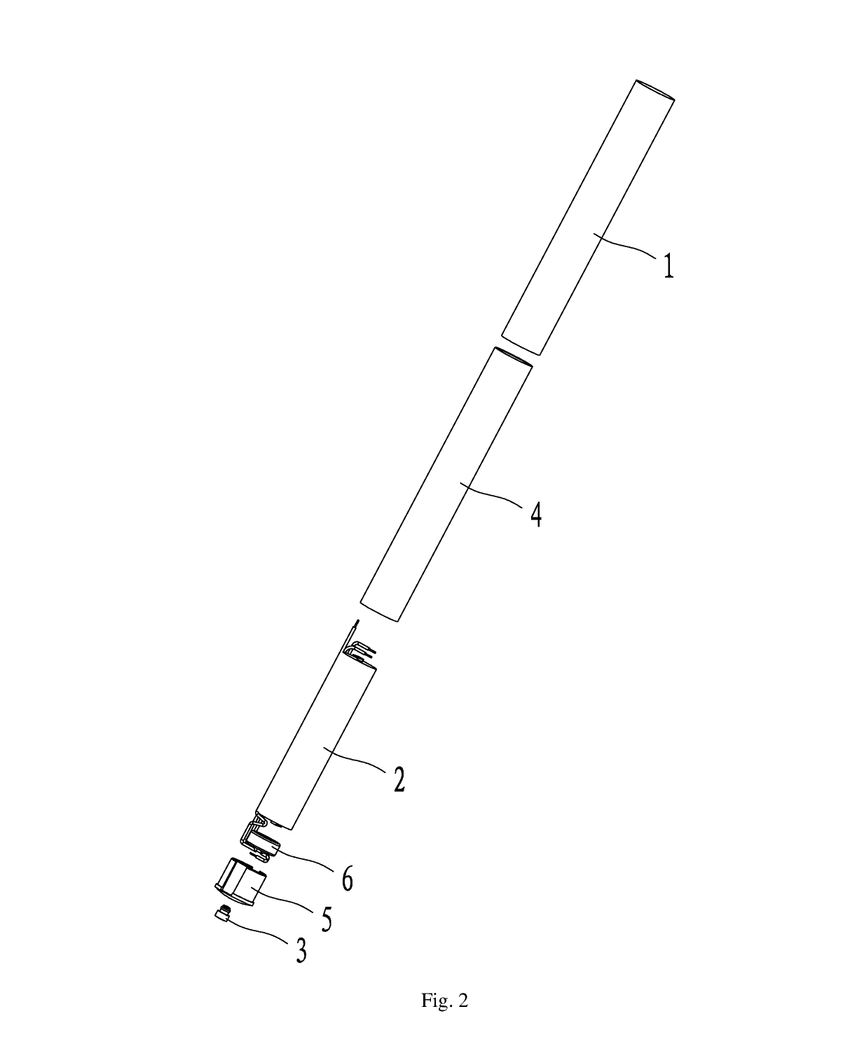

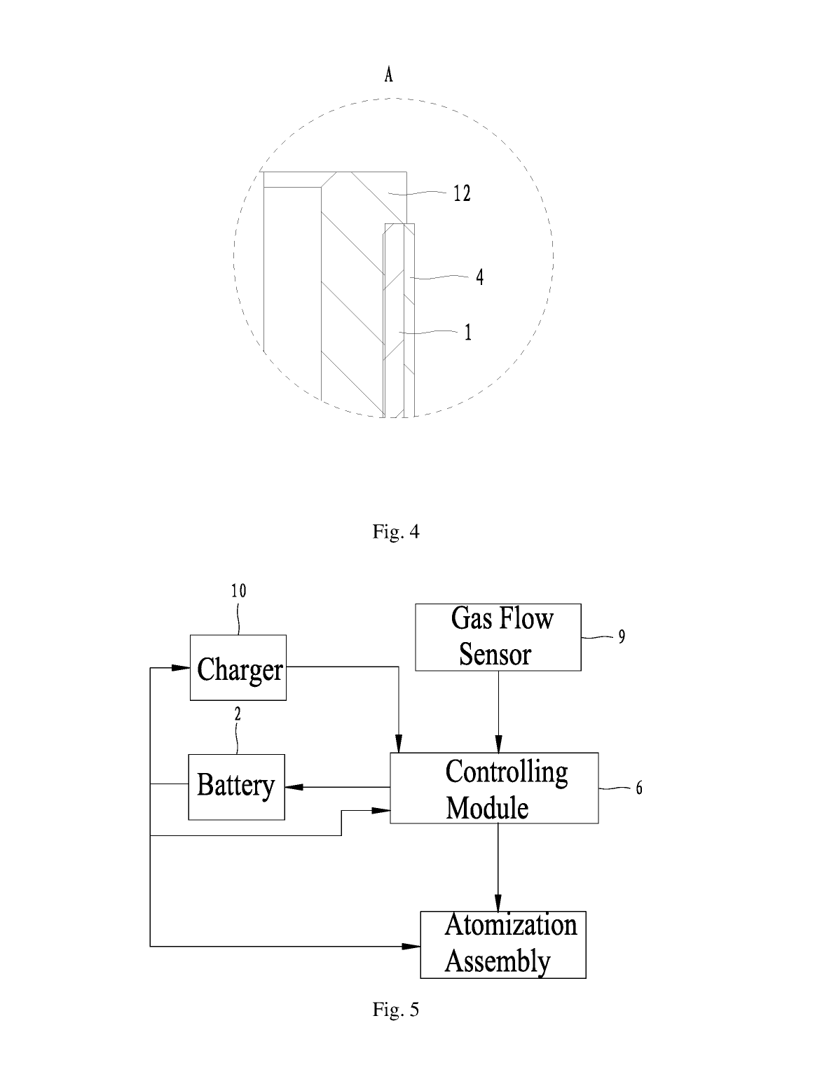

As shown in FIGS. 2, 3 and 4, in a first preferred embodiment of the present application, a battery component is provided, which is configured to be assembled with an atomization component (not shown) to form an electronic cigarette. The battery component comprises an outer sleeve pipe 1, a battery 2, a first charging electrode 3, a second charging electrode 4, a lamp cap 5, a controlling module 6, a first wire lead 7, a second wire lead 8, a gas flow sensor 9, a first electrode connecting element 11, a second electrode connecting element 12, and an insulating sleeve 13.

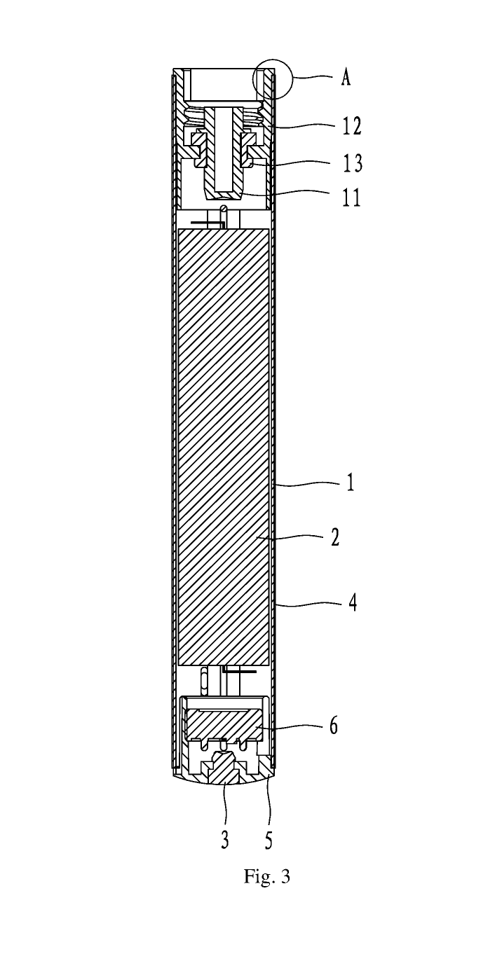

As shown in FIGS. 2 and 3, the outer sleeve pipe 1 is substantially in shape of a hollow cylinder. The battery 2 includes a first electrode 21 and a second electrode 22, and the battery 2 is arranged in the inner side of the outer sleeve pipe 1. In this embodiment, the first electrode 21 is a positive pole of the battery 2, while the second electrode 22 is a negative pole of the battery 2. The first electrode 21 and the second electrode 22 are respectively and electrically connected to the atomization component, in such a way that the atomization component is driven to work in order to produce smoke for a user to suck in.

As shown in FIGS. 2 and 3, the first charging electrode 3 is substantially a stepped construction in shape of a cylinder, wherein the first charging electrode 3 is arranged at one end of the outer sleeve pipe 1 and is electrically connected to the first electrode 21. The second charging electrode 4 is arranged on an outer wall of the outer sleeve pipe 1, and is further electrically connected to the second electrode 22. The first charging electrode 3 and the second charging electrode 4 are configured to be connected to an external charger 10, in order to achieve a charging operation of the battery component.

As shown in FIG. 3, the lamp cap 5 is inserted in the end of the outer sleeve pipe 1. When the atomization component is in a working state, the lamp cap 5 works, in order to indicate that the atomization component is in a working state. The first charging electrode 3 runs through the lamp cap 5 and is further electrically connected to the first electrode 21. Besides, the end of the first charging electrode 3 and the end of the lamp cap 5 together form an even surface. In this embodiment, the end of the lamp cap 5 that is located outside the outer sleeve pipe 1 is in shape of an arc, and accordingly, the end of the first charging electrode 3 that is located outside the outer sleeve pipe 1 is also in shape of an arc, and the lamp cap 5 and the first charging electrode 3 together form an evenly arc surface.

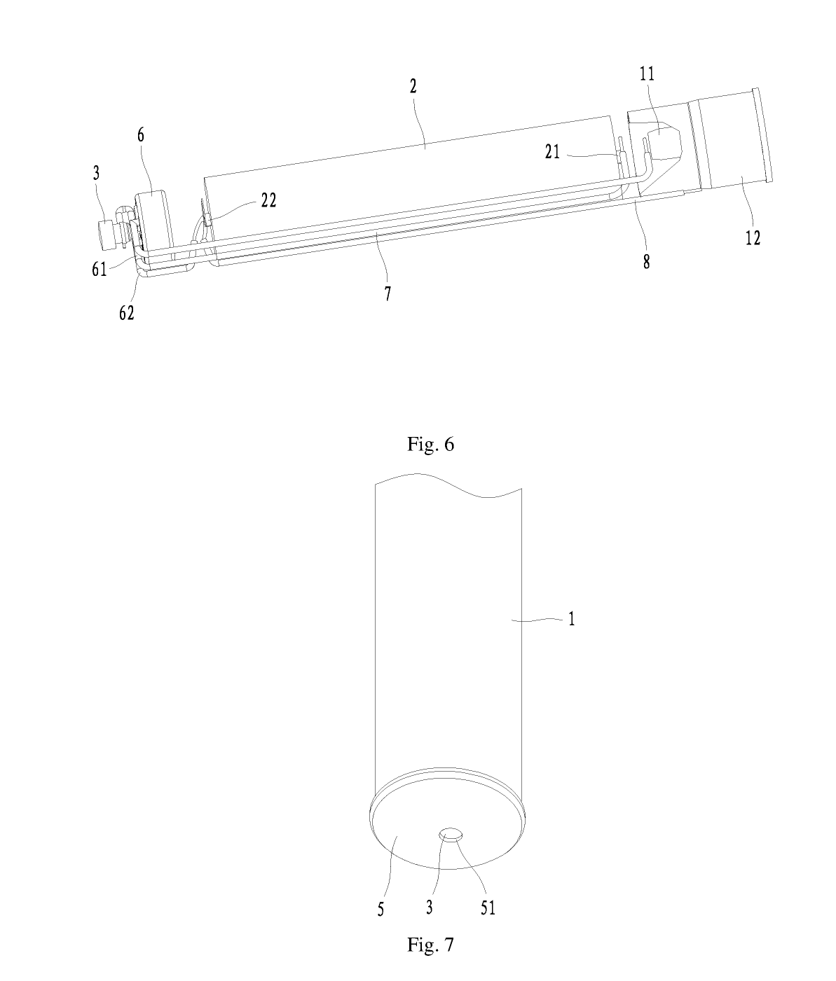

As shown in FIG. 6 and referring to FIG. 5 as well, the controlling module 6 includes a first electrode terminal 61 and a second electrode terminal 62. The first electrode terminal 61 and the second electrode terminal 62 are used as input terminals of the controlling module 6. The battery 2 may supply power to the controlling module 6 via the first electrode terminal 61 and the second electrode terminal 62. That is, the first electrode terminal 61 is electrically connected to the first electrode 21, while the second electrode terminal 62 is electrically connected to the second electrode 22. In this embodiment, the first electrode terminal 61 is abutted against the first charging electrode 3, in order to achieve the electrical connection between them. An output terminal of the controlling module 6 is connected to the atomization component, and is configured to control the working states of the atomization component. When the charger 10 is charging the battery 2, the controlling module 6 disconnect the battery 2 from the atomization component; in this way, it is possible to prevent the atomization component from working which in turns produces smoke during the charging process.

As shown in FIG. 5, the gas flow sensor 9 is connected to the controlling module 6. When the atomization component is in a normal working state, the controlling module 6 controls the battery 2 to supply power to the atomization component according to gas flow signals sensed by the gas flow sensor 9, in order to control the atomization component to produce smoke.

As shown in FIG. 3, the first electrode connecting element 11 and the second electrode connecting element 12 are respectively arranged on the other end of the outer sleeve pipe 1, and the first electrode connecting element 11 is electrically connected to the first electrode 21 while the second electrode connecting element 12 is electrically connected to the second electrode 22. The battery 2 is electrically connected to the atomization component via the first electrode connecting element 11 and the second electrode connecting element 12; in this way, the atomization component is driven to work to produce the smoke for the user to suck in. The insulating sleeve 13 is arranged between the first electrode connecting element 11 and the second electrode connecting element 12, such that first electrode connecting element 11 and the second electrode connecting element 12 are electrically insulated from each other.

As shown in FIGS. 2, 3 and 4, the second charging electrode 4 is arranged on the outer wall of the outer sleeve pipe 1, and is further electrically connected to the second electrode 22. The second charging electrode 4 is abutted against the second electrode connecting element 12, in order to achieve the electrical connection between them. Since the second electrode connecting element 12 is electrically connected to the second electrode 22, the second charging electrode 4 is electrically connected to the second electrode 22 as a result. In this embodiment, the second charging electrode 4 is an electrode tube (not labeled) which is sleeved on the outer wall of the outer sleeve pipe 1, and the electrode tube is made from conductive papers. An inner diameter of the electrode tube is adapted to an outer diameter of the outer sleeve pipe 1. An end of the electrode tube is abutted against the second electrode connecting element 12, and the electrode tube has a same length with the outer sleeve pipe 1. For the purpose of stably arranging the electrode tube on the outer wall of the outer sleeve pipe 1, an adhesive layer (not shown here) is further formed between the electrode tube and the outer sleeve pipe 1. The adhesive layer is configured to adhere the electrode tube onto the outer sleeve pipe 1. In this case, the adhesive layer may be made of glue, double sided adhesive tape, resin glue, or the like. In a further embodiment of the present application, the second charging electrode 4 is an electrode slice (not shown) which is arranged on the outer wall of the outer sleeve pipe 1. An end of the electrode slice is abutted against the second electrode connecting element 12, and the electrode slice has a same length with the outer sleeve pipe 1. It is also possible for the electrode slice to be fixedly arranged on the outer wall of the outer sleeve pipe 1 by means of adhering.

As shown in FIG. 6 and referring to FIG. 3 as well, the lamp cap 5 is inserted in the end of the outer sleeve pipe 1. The first wire lead 7 is connected to the first electrode terminal 61 and the first electrode 21, such that the first charging electrode 3 is electrically connected to the first electrode 21. The second wire lead 8 is respectively connected to the second electrode terminal 61, the second electrode 22, and the second electrode connecting element 12, such that the second charging electrode 4 is electrically connected to the second electrode 22.

When using the battery component described above, since the battery component employs the first charging electrode 3 which is arranged at one end of the outer sleeve pipe 1, and the second charging electrode 4 which is arranged on the outer wall of the outer sleeve pipe 1, when charging the battery component, only the first charging electrode 3 and the second charging electrode 4 need to be inserted into the external charger, thereby saving the charging time.

FIG. 7 shows a battery component according to a second preferred embodiment of the present application. The differences between the battery component in the second embodiment and that in the first embodiment lie in that, the mounting structures of the first charging electrode 3 and the lamp cap 5 are different. In the second embodiment, an inserting hole 51 configured for the first charging electrode 3 to run through is defined in the lamp cap 5. A bearing boss is formed between the first charging electrode 3 and the inserting hole 51. During the charging process, the charger 10 is inserted into the bearing boss, and is further abutted against the first charging electrode 3.

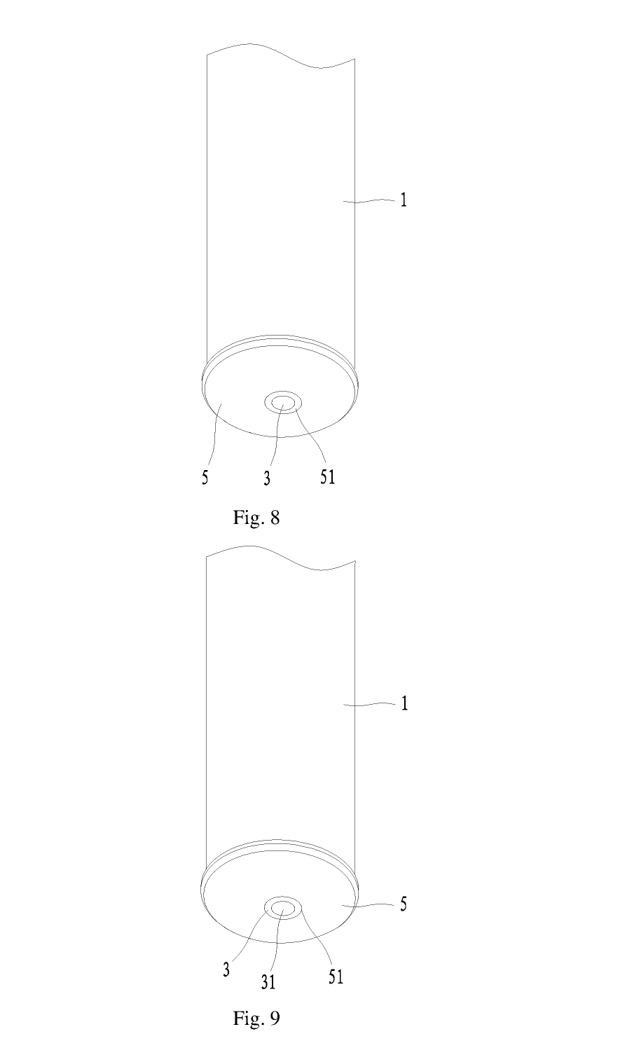

FIG. 8 shows a battery component according to a third preferred embodiment of the present application. The differences between the battery component in the third embodiment and that in the first embodiment also lie in that, the mounting structures of the first charging electrode 3 and the lamp cap 5 are different. In the third embodiment, an inserting hole 51 configured for the first charging electrode 3 to run through is defined in the lamp cap 5. A gap in shape of a barrel is formed between the first charging electrode 3 and the inserting hole 51. During the charging process, the charger 10 is inserted into the gap in shape of a barrel, and is further abutted against the first charging electrode 3.

FIG. 9 shows a battery component according to a fourth preferred embodiment of the present application. The differences between the battery component in the fourth embodiment and that in the first embodiment also lie in that, the mounting structures of the first charging electrode 3 and the lamp cap 5 are different. In the fourth embodiment, an inserting hole 51 configured for the first charging electrode 3 to run through is defined in the lamp cap 5. A charging hole 31 is defined in the first charging electrode 3 along an axis direction of the lamp cap 5, and the outer wall of the first charging electrode 3 is abutted against an inner wall of the inserting hole 51. During the charging process, the charger 10 is inserted into the charging hole 31, and is further abutted against the first charging electrode 3.

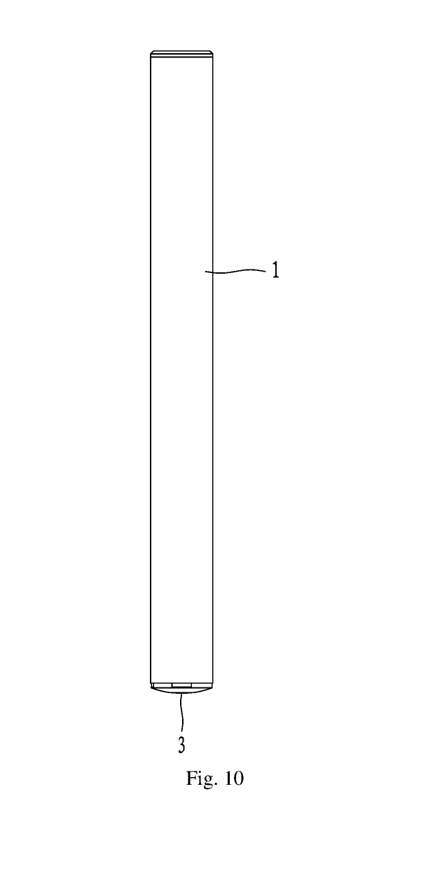

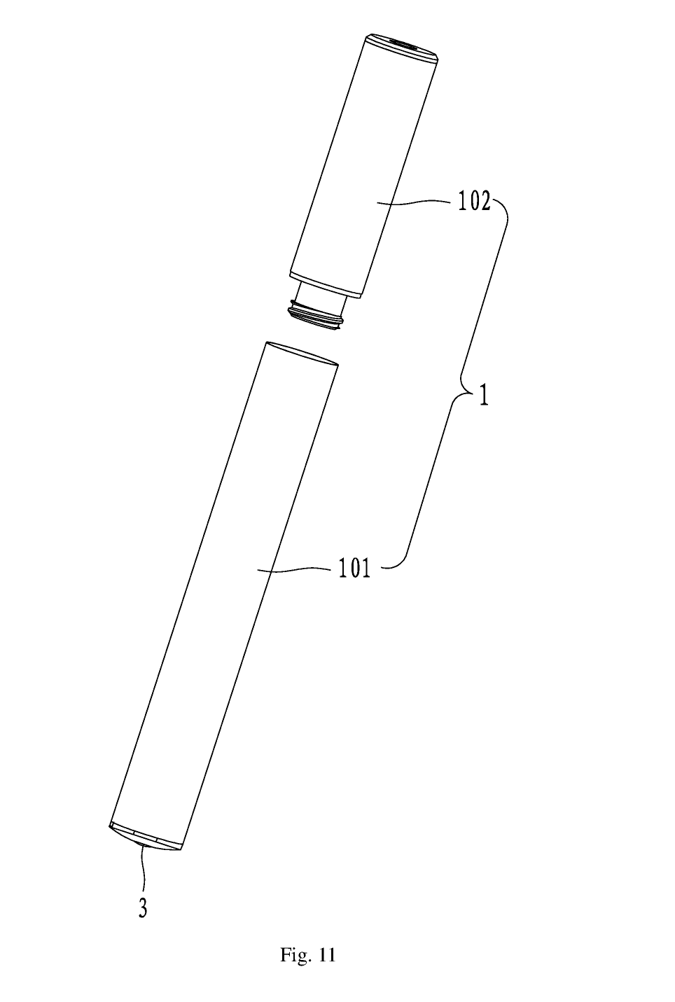

As shown in FIG. 10, based on the battery component having the structure described above, an electronic cigarette is further provided in the present application. In a first preferred embodiment of the present application, the electronic cigarette comprises the battery component as described in the embodiments above, and an atomization component arranged inside the outer sleeve pipe 1. The electronic cigarette in this embodiment is a common disposable electronic cigarette, that is, in this electronic cigarette, the battery component and the atomization component use a common outer sleeve pipe.

FIG. 11 shows an electronic cigarette according to a second preferred embodiment of the present application. The difference between the electronic cigarette in the second embodiment and that in the first embodiment lies in that, the structures of the outer sleeve pipe 1 are different. In the second embodiment, the outer sleeve pipe 1 includes a battery sleeve tube 101, and an atomization sleeve tube 102 detachably connected to the battery sleeve tube 101. The battery sleeve tube 101 and the atomization sleeve tube 102 are connected to each other by a thread connection. The battery 2 is arranged in the battery sleeve tube 101, while the atomization component is arranged in the atomization sleeve tube 102. The first charging electrode 3 is arranged at one end of the battery sleeve tube 101 that is opposite to the atomization sleeve tube 102, while the second charging electrode 4 is arranged on an outer wall of the battery sleeve tube 101. In further embodiments of the present application, it is possible for the battery sleeve tube 101 and the atomization sleeve tube 102 to be connected to each other in other detachable connection methods, such as buckling connection, or the like.

When using the electronic cigarette of the present application, since the battery component employs the first charging electrode 3 which is arranged at one end of the outer sleeve pipe 1, and the second charging electrode 4 which is arranged on the outer wall of the outer sleeve pipe 1, when charging the battery component, only the first charging electrode 3 and the second charging electrode 4 need to be inserted into the external charger, thereby saving the charging time. Furthermore, since there is no need to separate the battery sleeve tube 101 and the atomization sleeve tube 102 from each other, it is possible to ensure a reliable connection between the battery sleeve tube 101 and the atomization sleeve tube 102, which brings lots of conveniences to the users.

Although the present application is illustrated with the embodiments accompanying the drawings, the present application is not limited to the above-mentioned specific embodiments, and the above-mentioned embodiments are only for illustration, not for limitation. In the inspiration of the present application, those skilled in the art may make many modifications, without going beyond the purpose and the scope the claims intend to protect of the present application. All these belong to the protection of the present application.

1. A battery component, configured to be assembled with an atomization component to form an electronic cigarette, and comprising an outer sleeve pipe (1) and a battery (2) arranged in the outer sleeve pipe (1); the battery (2) including a first electrode (21) and a second electrode (22); wherein the battery component further includes a first charging electrode (3) which is arranged at one end of the outer sleeve pipe (1) and further electrically connected to the first electrode (21), and a second charging electrode (4) which is arranged on an outer wall of the outer sleeve pipe (1) and further electrically connected to the second electrode (22); the first charging electrode (3) and the second charging electrode (4) are configured to be connected to an external charger (10).

2. The battery component according to claim 1, wherein the battery component further includes a lamp cap (5) which is inserted in the end of the outer sleeve pipe (1); the first charging electrode (3) runs through the lamp cap (5) and is further electrically connected to the first electrode (21).

3. The battery component according to claim 2, wherein an end face of the first charging electrode (3) and an end face of the lamp cap (5) together form an even surface.

4. The battery component according to claim 2, wherein an inserting hole (51) configured for the first charging electrode (3) to run through is defined in the lamp cap (5), while a gap in shape of a barrel is formed between the first charging electrode (3) and the inserting hole (51).

5. The battery component according to claim 2, wherein an inserting hole (51) configured for the first charging electrode (3) to run through is defined in the lamp cap (5), while a charging hole (31) is defined in the first charging electrode (3) along an axis direction of the lamp cap (5).

6. The battery component according to claim 2, wherein the battery component further includes a first electrode connecting element (11) and the second electrode connecting element (12) which are respectively arranged on the other end of the outer sleeve pipe (1) that is opposite to the first charging electrode (3); the first electrode connecting element (11) is electrically connected to the first electrode (21), while the second electrode connecting element (12) is electrically connected to the second electrode (22); the second charging electrode (4) is abutted against the second electrode connecting element (12).

7. The battery component according to claim 6, wherein the second charging electrode (4) is an electrode tube which is sleeved on the outer wall of the outer sleeve pipe (1); an end of the electrode tube is abutted against the second electrode connecting element (12).

8. The battery component according to claim 7, wherein the electrode tube is made from conductive papers.

9. The battery component according to claim 6, wherein the second charging electrode (4) is an electrode slice which is arranged on the outer wall of the outer sleeve pipe (1); an end of the electrode slice is abutted against the second electrode connecting element (12).

10. The battery component according to claim 1, wherein the battery component further includes a controlling module (6) which is configured to control the atomization component to work; the controlling module (6) includes a first electrode terminal (61) which is electrically connected to the first electrode (21), and a second electrode terminal (62) which is electrically connected to the second electrode (22); the first charging electrode (3) is abutted against the first electrode terminal (61);
when the charger (10) is charging the battery (2), the controlling module (6) disconnects the battery (2) from the atomization component.

11. An electronic cigarette, comprising a battery component; the battery component including an outer sleeve pipe (1) and a battery (2) arranged in the outer sleeve pipe (1); the battery (2) comprising a first electrode (21) and a second electrode (22); the electronic cigarette further including an atomization component arranged in the outer sleeve pipe (1); wherein the battery component further includes a first charging electrode (3) which is arranged at one end of the outer sleeve pipe (1) and further electrically connected to the first electrode (21), and a second charging electrode (4) which is arranged on an outer wall of the outer sleeve pipe (1) and further electrically connected to the second electrode (22); the first charging electrode (3) and the second charging electrode (4) are configured to be connected to an external charger (10).

12. The electronic cigarette according to claim 11, wherein the outer sleeve pipe (1) includes a battery sleeve tube (101) and an atomization sleeve tube (102) detachably connected to the battery sleeve tube (101); the battery (2) is arranged in the battery sleeve tube (101); the first charging electrode (3) is arranged at one end of the battery sleeve tube (101) that is opposite to the atomization sleeve tube (102), while the second charging electrode (4) is arranged on an outer wall of the battery sleeve tube (101); the atomization component is arranged in the atomization sleeve tube (102).

13. The electronic cigarette according to claim 12, wherein the battery component further includes a lamp cap (5) which is inserted in the end of the battery sleeve tube (101) that is opposite to the atomization sleeve tube (102); the first charging electrode (3) runs through the lamp cap (5) and is further electrically connected to the first electrode (21).

14. The electronic cigarette according to claim 13, wherein an end face of the first charging electrode (3) and an end face of the lamp cap (5) together form an even surface.

15. The electronic cigarette according to claim 13, wherein an inserting hole (51) configured for the first charging electrode (3) to run through is defined in the lamp cap (5), while a gap in shape of a barrel is formed between the first charging electrode (3) and the inserting hole (51).

16. The electronic cigarette according to claim 13, wherein the battery component further includes a first electrode connecting element (11) and the second electrode connecting element (12) which are respectively arranged on the other end of the battery sleeve tube (101) that is opposite to the first charging electrode (3); the first electrode connecting element (11) is electrically connected to the first electrode (21), while the second electrode connecting element (12) is electrically connected to the second electrode (22); the second charging electrode (4) is abutted against the second electrode connecting element (12).

17. The electronic cigarette according to claim 16, wherein the second charging electrode (4) is an electrode tube which is sleeved on the outer wall of the battery sleeve tube (101); an end of the electrode tube is abutted against the second electrode connecting element (12).

18. The electronic cigarette according to claim 17, wherein the electrode tube is made from conductive papers.

19. The electronic cigarette according to claim 16, wherein the second charging electrode (4) is an electrode slice which is arranged on the outer wall of the battery sleeve tube (101); an end of the electrode slice is abutted against the second electrode connecting element (12).

20. The electronic cigarette according to claim 12, wherein the battery component further includes a controlling module (6) which is configured to control the atomization component to work; the controlling module (6) includes a first electrode terminal (61) which is electrically connected to the first electrode (21), and a second electrode terminal (62) which is electrically connected to the second electrode (22); the first charging electrode (3) is abutted against the first electrode terminal (61);
when the charger (10) is charging the battery (2), the controlling module (6) disconnects the battery (2) from the atomization component.
